(19) United States
(12) Patent Application Publication
(10) Pub. No.: US 2009/0175621 A1
(43) Pub. Date: Jul. 9, 2009

(54) Optical code division multiplexing module and method

(75) Inventors: Shuko Kobayashi, Tokyo (JP); Satoko Katsuzawa, Tokyo (JP); Kensuke Sasaki, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/292,388

(22) Filed: Nov. 18, 2008

(30) Foreign Application Priority Data
Jan. 8, 2008 (JP) 2008-001299

(51) Int. Cl. H04J 14/00; G02B 26/00

(52) U.S. Cl. 398/77; 359/290

(57) ABSTRACT

An optical code division multiplexing module includes a superstructured fiber Bragg grating having equally spaced unit fiber Bragg gratings that convert an optical pulse into an optical chip train with equal inter-chip phase differences. A thermo-module heats or cools the mounting plate to which the superstructured fiber Bragg grating is secured. A temperature sensor measures the temperature of the mounting plate, and a temperature controller adjusts the temperature, thereby adjusting the inter-chip phase difference. The optical code division multiplexing module can be used for both coding and decoding. The inter-chip phase difference defines the code. Operation is stable despite environmental variations, and the code can be changed by changing the temperature setting, without replacement of any physical parts.

### BACKGROUND OF THE INVENTION

1. Field of the Invention

The present invention relates to an optical code division multiplexing module and an optical code division multiplexing encoding method that permit the code to be changed without replacement of the encoder and decoder devices.

2. Description of the Related Art

With the spread of the Internet in recent years, communication demand is growing rapidly. To address this expanding need for communication, high-speed large-capacity optical networks using optical fibers are being developed. Much effort is going into the development of wavelength division multiplexing (WDM) networks, and in particular dense wavelength division multiplexing (DWDM) networks, in which the wavelengths of the multiplexed optical carrier signals assigned to different communication channels are densely spaced on the optical wavelength axis.

In addition to WDM and DWDM, optical code division multiplexing (OCDM) is also attracting notice. In an OCDM communication system, the individual optical pulses constituting the signals for different channels are encoded with different codes, and the encoded signals are combined and transmitted as a multiplexed optical signal. At the receiving end, the same codes are used to decode the multiplexed signal and extract the original optical pulse signals. OCDM communication systems can achieve high multiplexing rates, and they offer a degree of security because the signals are transmitted in an encoded form. OCDM can also be combined with WDM or DWDM to improve the wavelength utilization efficiency.

Known OCDM systems include both wavelength-hopping/time-spreading systems and phase-coding systems. A wavelength-hopping/time-spreading OCDM system separates an optical pulse signal with a continuum of wavelengths into optical chip pulse signals of different individual wavelengths; the allocation sequence of the individual wavelengths to the optical chip pulses constitutes the code. In a phase-coding system, the chip pulse signals have the same wavelength and the code is defined by the sequence of relative phase differences between the optical chip pulses. The encoders and decoders used in phase-coding OCDM systems will be referred to as phase encoders and phase decoders below.

One type of encoder and decoder widely used in OCDM employs a fiber Bragg grating (FBG). An FBG is an optical fiber with a diffraction grating formed inside its core to reflect light of a particular wavelength. The encoders and decoders in phase-coding OCDM systems usually employ a superstructured fiber Bragg grating (SSFBG) having a plurality of identical FBGs (unit FBGs) in the same optical fiber. The intervals between adjacent unit FBGs determine the code. Typically, the intervals are either zero or have a prescribed positive length.

In SSFBG-based phase encoders and phase decoders, because the code is defined by the intervals between the adjacent unit FBGs, the code is fixed. A consequent problem is that when the code is changed, the encoders and decoders must be replaced.

Mokhtar et al. have described a method of changing the code used by an SSFBG encoder or decoder by providing a plurality of tungsten wires in contact with the SSFBG at fixed intervals and using local heating by the tungsten wires to adjust the phase shifts (‘Reconfigurable Multilevel Phase-Shift Keying Encoder-Decoder for All-Optical Networks’, IEEE Photonics Technology Letters, Vol. 15, No. 3, March 2003). There is a tendency, however, for the locally heated area to expand due to heat transfer in the optical fiber, thereby changing the phase shifts and altering the code. Stable operation cannot be maintained for an extended time.

Tsuda et al. have described another type of OCDM phase encoder and decoder, in which the coding is performed by an arrayed-waveguide grating (AWG) and a phase filter that separate signal pulses into different wavelength components (‘Photonic spectral encoder/decoder using an arrayed-waveguide grating for coherent optical code division multiplexing’, OFC/IOOC '99 Technical Digest, Feb. 21-26, 1999, PD32/1-3). This type of OCDM phase encoder and decoder can be configured as a part of a planar waveguide, enabling integration with other optical elements such as delay elements and circulators, but there are difficulties such as large size, high cost, and high insertion loss in the transmission paths of optical fiber networks.

Research carried out by the present inventors has shown that even wavelength differences as small as a few picometers between the encoder and decoder can jeopardize the success of encoding and decoding. Therefore, if paired encoders and decoders of the type described by Mokhtar et al. or Tsuda et al. are used in different ambient temperature conditions, or if the ambient temperature changes, encoding and decoding are likely to fail due to unmatched reflection center wavelengths between the encoders and decoders.

### SUMMARY OF THE INVENTION

An object of the present invention is to provide an optical code division multiplexing module and method that enable the code to be changed whenever required, without replacement of the encoder and decoder, and also provide long-term stability of operation.

Through diligent research, the present inventors have found that this object can be achieved by providing the encoder and decoder with respective SSFBGs each having a plurality of mutually identical unit fiber Bragg gratings equally spaced in a single optical fiber. A constant uniform spacing is maintained by a temperature controller that holds the entire SSFBG at a constant uniform temperature. The code can be changed as necessary simply by changing the temperature setting.

An optical signal pulse entering an encoder having this type of SSFBG emerges as train of equally spaced optical chip pulses with a uniform phase difference between adjacent chip pulses. The phase difference defines the code.

If the encoder and decoder have SSFBGs with the same constant uniform spacing between unit fiber Bragg gratings, optical chip pulse signals reflected by the unit fiber Bragg gratings of the decoder align on the time axis, and the aligned chip pulses are in phase with one another. Accordingly, an autocorrelation peak occurs in the output from the decoder, enabling the optical pulse signal to be reproduced.

If the encoder and decoder have unit fiber Bragg gratings are spaced at different intervals, the optical chip pulse signals reflected by the unit fiber Bragg gratings of the decoder do not align on the time axis and are out of phase with one another. The output from the decoder does not have an autocorrelation peak, making it impossible to reproduce the optical pulse signal.

A change in the temperature of the SSFBGs changes the phase difference between adjacent optical chip pulse signals. Accordingly, the code of the encoder or decoder can be changed by changing the temperature of the SSFBG.

An optical code division multiplexing module according to a first aspect of the present invention includes an SSFBG, a mounting plate, a thermo-module, a temperature sensor, and a temperature controller.

The SSFBG has a plurality of identical fiber Bragg gratings equally spaced in a single optical fiber. The SSFBG is secured to the mounting plate. The thermo-module heats or cools the mounting plate. The temperature sensor measures the temperature of the mounting plate. The temperature controller controls the thermo-module according to the temperature measured by the temperature sensor so as to adjust the temperature of the mounting plate, thereby setting a code for encoding or decoding by phase modulation.

In the optical code division multiplexing module structured as described above, the SSFBG preferably has M unit fiber Bragg gratings, M being an integer greater than one, equal to the code length of the code. An optical pulse signal entering the SSFBG re-emerges as M optical pulse signals reflected by the M unit fiber Bragg gratings. The phase difference between optical pulse signals reflected by adjacent unit fiber Bragg gratings should be uniform. This phase difference determines the code of the optical code division multiplexing module.

In a preferred embodiment of the optical code division multiplexing module described above, a change in temperature of the mounting plate changes the phase difference.

In another preferred embodiment of the optical code division multiplexing module of the present invention, N codes are available, N being an integer equal to or greater than one, and the phase difference Δφ of the a-th code, a being an arbitrary integer from one to N, is given by the expression:

Δφ=(2a−1)*π/N.

A method of encoding an optical signal by using an optical code division multiplexing module according to a second aspect of the present invention includes a step of inputting an optical signal into an SSFBG and a step of reflecting the optical signal at the unit fiber Bragg gratings in the SSFBG to generate an encoded signal including M optical pulses, with a uniform phase difference between the pulses reflected by adjacent unit fiber Bragg gratings. The phase difference defines the code of the optical code division multiplexing module.

In a preferred embodiment of the encoding method described above, a change in temperature of the mounting plate changes the phase difference.

The optical code division multiplexing module and method of the present invention use an SSFBG having a plurality of identical unit fiber Bragg gratings with equal spacing as the encoder and decoder, and the code is changed by changing the temperature of the SSFBG. This eliminates the need for local heating to define the code and enables encoding and decoding with the desired code to proceed with long-term stability, even in the presence of environmental temperature variations.

By changing the temperature of the entire SSFBG, the code can be changed easily.

### BRIEF DESCRIPTION OF THE DRAWINGS

In the attached drawings:

FIG. 1 is a schematic block diagram of an OCDM module;

FIG. 2 is a schematic sectional side view of a module package including the OCDM module;

FIG. 3 is a schematic sectional view of a buffer provided in the module package in FIG. 2;

FIG. 4 is a schematic sectional side view of an SSFBG used as an encoder or decoder;

FIG. 5 is a diagram illustrating the encoding of an optical pulse to produce a chip pulse train;

FIG. 6 is a diagram illustrating the decoding of the chip pulse train;

FIG. 7 is a graph illustrating the relationship between SSFBG temperature and reflected wavelength;

FIGS. 8A to 8D show waveforms of decoded signals; and

FIG. 9 is a graph showing the relationship between wavelength variation in the encoder and reflected power in the decoder.

### DETAILED DESCRIPTION OF THE INVENTION

A novel optical code division multiplexing (OCDM) module embodying the invention will now be described with reference to the attached non-limiting drawings, in which like elements are indicated by like reference characters.

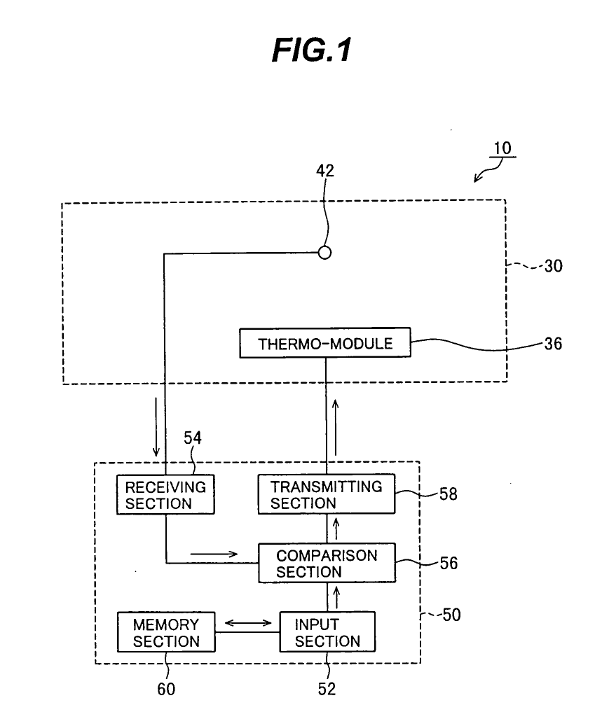

Referring to FIG. 1, the novel OCDM module 10 includes a module package 30 and a temperature controller 50.

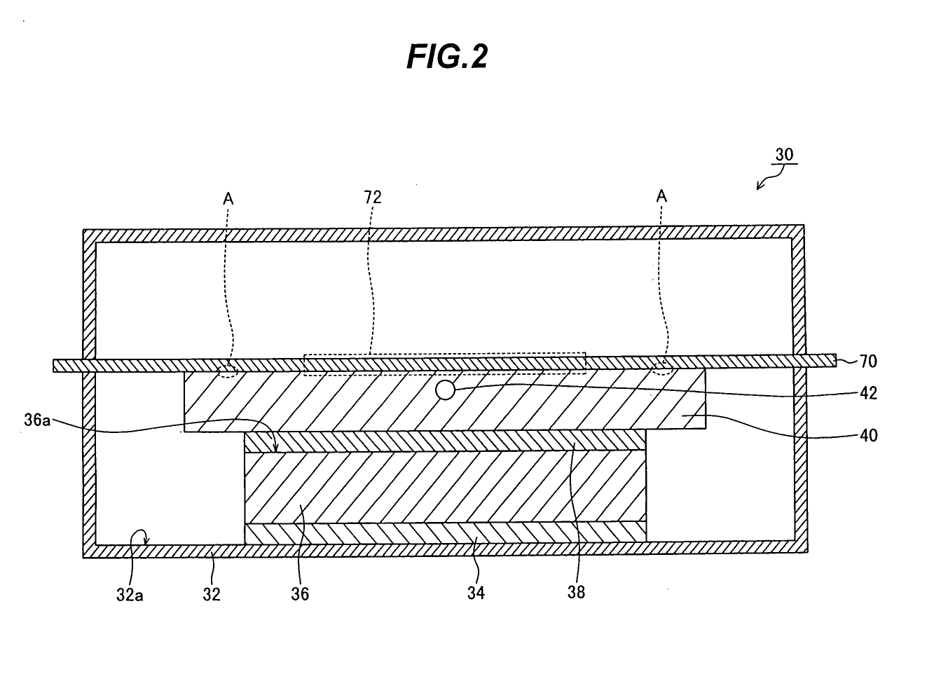

Referring to FIG. 2, the module package 30 has a housing 32 enclosing a thermo-module 36, a mounting plate 40, a temperature sensor 42, and a superstructured fiber Bragg grating (SSFBG) 72. The thermo-module 36 is secured to the bottom inner surface 32a of the housing 32 through a buffer 34, and to a mounting plate 40 through another buffer 38 disposed on the top surface 36a of the thermo-module 36.

An optical fiber 70 is attached to the mounting plate 40 at two points (e.g., the positions indicated by the letter A in FIG. 2) separated in the optical propagation direction, in a state such that the fiber is under no forces of tension or compression and is in close contact with the mounting plate 40 between the two points. The attachment may be effected by an adhesive agent such as an ultraviolet curable acrylic adhesive (e.g., the type VTC-2 ultraviolet curing optical cement manufactured by Summers Optical of Hatfield, Pa.) or by an epoxy-based adhesive.

In the description below, the optical propagation direction of the optical fiber 70 will also be referred to as the longitudinal direction of the module package 30 or simply as the longitudinal direction.

The fiber used as the optical fiber 70 is a single-mode optical fiber having a core doped with germanium or an equivalent substance to provide increased ultraviolet photosensitivity. The SSFBG 72 is formed in the optical fiber 70 between the two points of attachment to the mounting plate 40. The SSFBG 72 will be described later in more detail.

The housing 32 may be formed from for example, gold-plated aluminum. The main material of the housing 32 is not limited to aluminum, however; another inexpensive and easy-to-work material, such as copper, can be used instead.

The housing 32 is box-shaped and has electrical terminals (not shown) on one side surface for supplying power to the thermo-module 36 and for input of a signal from the temperature sensor 42. The housing 32 preferably has a main body and an openable or detachable lid to facilitate installation of thermo-module 36, mounting plate 40, temperature sensor 42, SSFBG 72, and so on. The lid is opened or detached in order to place those elements in the main body, and is closed or attached after the elements have been mounted and secured.

The thermo-module 36 employs, for example, a Peltier element as a heating and cooling device. The thermo-module 36 receives current fed from the temperature controller 50 through the power supply terminals and heats or cools the mounting plate 40 by generating or dissipating heat, depending on the current direction, at a rate that depends on the magnitude of the current. The longitudinal length of the heating or cooling range of the package containing the thermo-module 36 is preferably greater than or equal to the longitudinal length of the SSFBG 72, so that the temperature of the entire SSFBG 72 can be kept uniform.

Buffer 34 is disposed between the housing 32 and thermo-module 36; buffer 38 is disposed between the thermo-module 36 and mounting plate 40. Both buffers 34 and 38 have the same structure; buffer 34 will be described below.

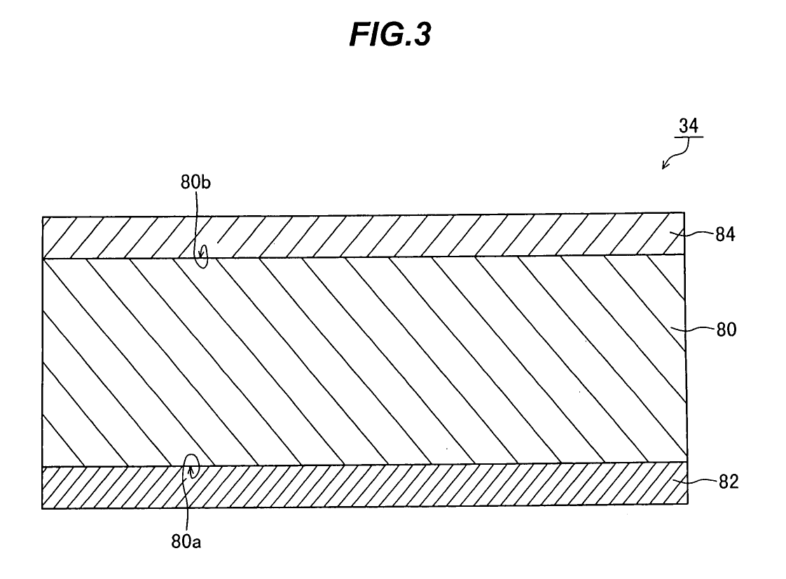

Referring to FIG. 3, buffer 34 includes a buffer layer 80 with adhesive layers 82 and 84 on its lower surface 80a and upper surface 80b. A preferred material of the buffer layer 80 has a planar elasticity modulus of 10% or greater and a heat transfer coefficient of 1 W/m·K or greater. The adhesive layers 82, 84 are made from an acrylic or urethane material having an adhesive strength of 5 N/cm or greater, as measured in a 180-degree delamination test, and a high shear adhesion strength, e.g., a shift of less than 0.1 mm under a 1-kg load.

The buffers 34 and 38 are not limited to the structures and materials described above. If the material used as the buffer layer 80 itself has the elasticity, adhesion capacity, and shear adhesion properties described above, the buffers 34 and 38 may have a single-layer structure.

Referring again to FIG. 2, the mounting plate 40 has, for example, the shape of a prism with a groove formed in its top surface to accommodate the optical fiber 70. The mounting plate 40 is preferably made of a material having a high thermal conductivity and a low thermal expansion coefficient, such as the SSC-802-CI composite of silicon carbide (SiC) ceramic and silicon (Si) manufactured by M Cubed Technologies Inc., of Monroe, Conn. The SSC-802-CI material has a thermal conductivity of 190 W/m·K, which is equivalent to that of aluminum, and a thermal expansion coefficient of 1.7×10⁻⁶/K, which is equivalent to that of the well-known iron-nickel alloy Invar.

The temperature sensor 42 is disposed on the top surface of the mounting plate 40, the surface on which the optical fiber 70 is mounted, or is embedded in the top or a side surface of the mounting plate 40. The temperature sensor 42 measures the temperature of the mounting plate 40 and outputs an electric signal corresponding to the measured temperature. Since the SSFBG 72 is lodged in the groove formed in the top surface of the mounting plate 40, the temperature of the SSFBG 72 is substantially the same as the temperature of the mounting plate 40.

The temperature sensor 42 sends the electric signal to the temperature controller 50, through an output terminal provided in the housing 32 of the module package 30. A thermistor, a thermocouple, or a platinum thermal resistor, for example, may be used as the temperature sensor 42.

Referring again to FIG. 1, the temperature controller 50 includes an input section 52, a signal receiving section 54, a comparison section 56, a signal transmitting section 58, and a memory section 60. The temperature controller 50 controls the thermo-module 36 in accordance with the temperature measured by the temperature sensor 42 and adjusts the temperature of the mounting plate 40. The code for encoding or decoding by phase modulation is set by adjusting the temperature.

The memory section 60 readably stores reference data measured beforehand in accordance with the characteristics of the phase encoder. The reference data associate the code of the phase encoder with the temperature of the SSFBG included in the phase encoder.

When the user inputs information specifying a desired code to the input section 52, the input section 52 reads the reference data from the memory section 60 and sets the appropriate temperature of the SSFBG. The temperature setting is sent to the comparison section 56.

The signal receiving section 54 receives the electric signal representing the temperature of the mounting plate 40 from the module package 30. The signal receiving section 54 converts the received electric signal to measured temperature information and sends this information to the comparison section 56.

The comparison section 56 compares the temperature setting received from the input section 52 and the measured temperature received from the signal receiving section 54 and determines from the result of the comparison whether the thermo-module 36 needs to perform a heating or cooling operation, and if so, by how much, to bring the measured temperature to the set temperature. The comparison section 56 sends the result of this determination to the signal transmitting section 58 as control information.

The signal transmitting section 58 supplies current corresponding to the control information received from the comparison section 56 through the power supply terminals of the housing 32 to the thermo-module 36.

The temperature controller 50 may use any known scheme for controlling the temperature of an object according to a target value, that is, for bringing the temperature of the object to the target value. A person skilled in the art can also easily configure means for associating temperatures with codes and setting the target temperature according an input code specification, by using conventional technology. The module may also be structured so that the user inputs the target temperature itself to the input section 52, instead of specifying a code.

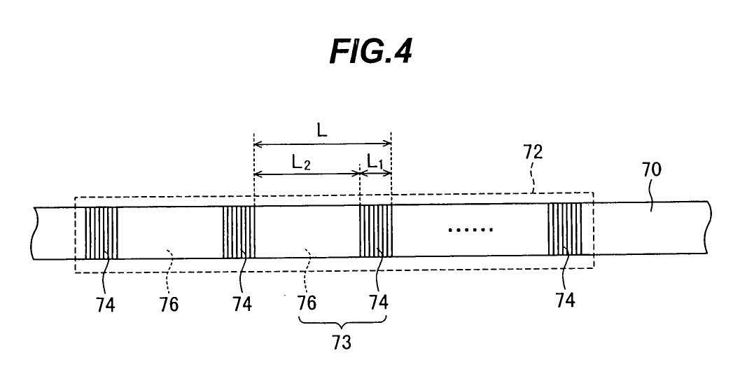

Referring to FIG. 4, the SSFBG 72 has a multi-point phase shift structure in which a plurality of unit fiber Bragg gratings (unit FBGs) 74 are mutually separated by a plurality of phase adjustment regions 76 in the same optical fiber 70. The unit FBGs 74 have identical lengths L1 and identical internal structures, and are equally spaced. Because the unit FBGs 74 are equally spaced, the phase adjustment regions 76 have identical lengths L2. A pair consisting of a unit FBG 74 and an adjacent phase adjustment region 76 form a unit chip 73; all the unit chips 73 have the same length L.

In the following description, the SSFBG 72 used as the phase encoder includes M unit FBGs 74 and thus produces a code of length M, where M is an integer greater than one. The number of different codes that can be generated is N, where N is also an integer greater than one. M is an integer multiple of N (N multiplied by an integer greater than or equal to one).

An optical pulse signal input to the SSFBG 72 is reflected by the unit FBGs 74 to generate M optical chip pulses. Because the unit FBGs 74 are equally spaced, the M optical chip pulses are equally spaced on the time axis. The optical chip pulses reflected by mutually adjacent pairs of the unit FBGs 74 become mutually adjacent optical chip pulses on the time axis and have a uniform phase difference Δφ, which defines the code.

If an a-th one of the N available codes is used for encoding (a is an integer from one to N), the spacing between the adjacent unit FBGs 74, or the length La of the unit chip 73, is set to bring the phase difference Δφ between the adjacent optical chip pulses to the value given by the following equation:

Δφ=(2a−1)×π/N

To configure an encoder to produce a b-th code differing from the a-th code, it suffices to alter the length of the phase adjustment region 76 from La to Lb; the other conditions should be the same. The conditions

Δφa=(2a−1)×π/N

and

Δφb=(2b−1)×π/N

are specified on the assumption that the SSFBG temperature is at a common reference temperature.

A phase decoder for decoding the signal encoded with the a-th code should use an SSFBG having the same structure as that of the a-th phase encoder. Identical OCDM modules may be used in both the transmitter and the receiver.

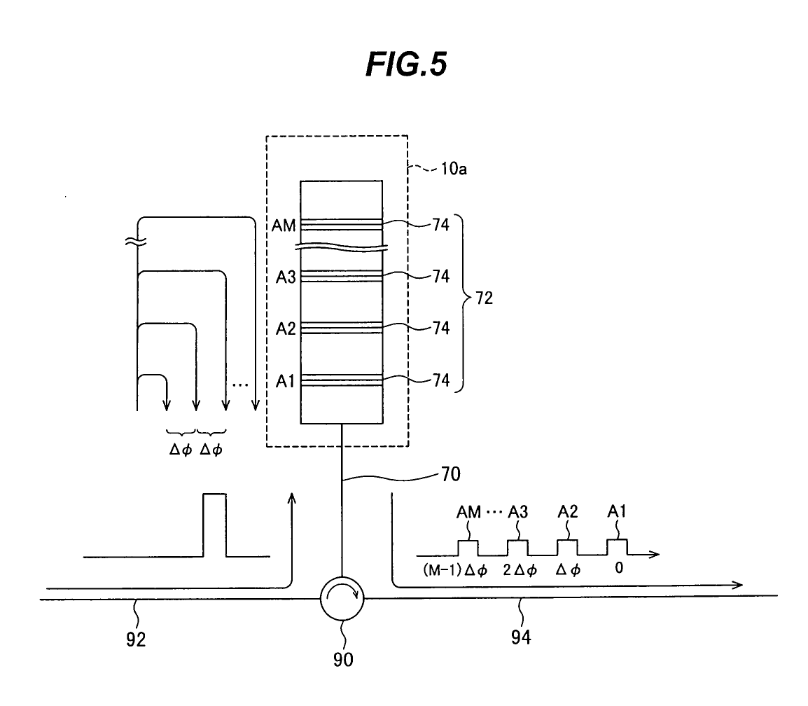

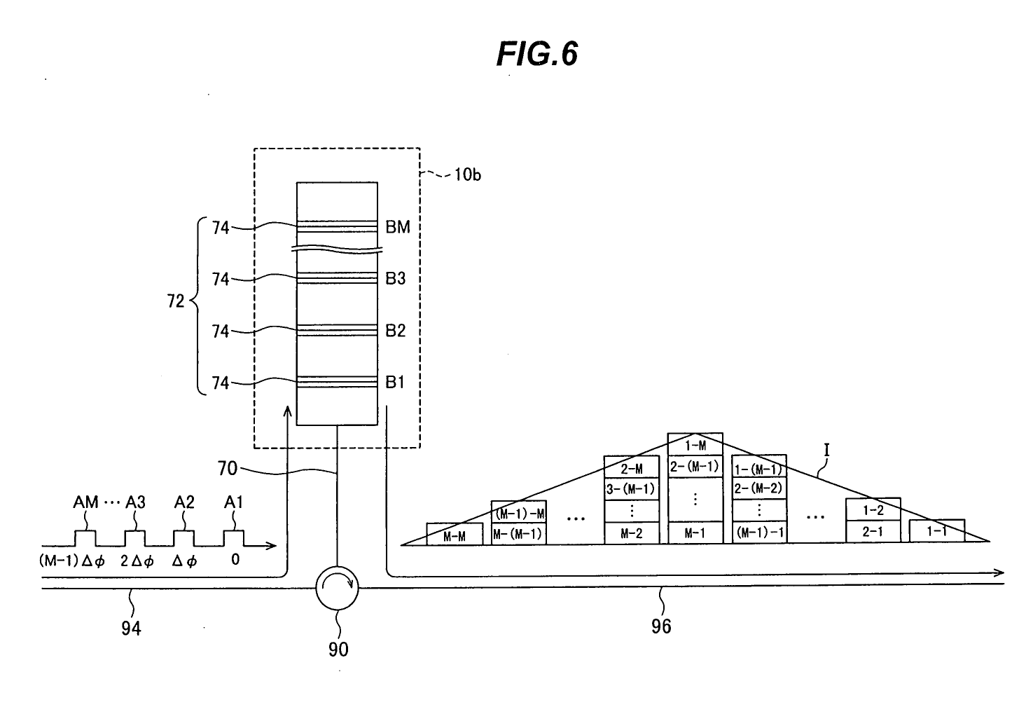

Encoding and decoding methods using the novel OCDM module will be described below with reference to FIG. 5, which illustrates the encoding scheme, and FIG. 6, which illustrates the decoding scheme.

The unit FBGs 74 in the encoder SSFBG 72 in the transmitting OCDM module 10a are denoted A1, A2, . . . , AM in FIG. 5, where A1 is near the input-output end of the SSFBG. The unit FBGs 74 in the decoder SSFBG 72 in the receiving OCDM module 10b in FIG. 6 are denoted B1, B2, . . . , BM, where B1 is near the input-output end of the SSFBG. The input-output ends of the optical fibers 70 are connected to optical circulators 90. The SSFBG parts of the optical fibers 70 inside the OCDM modules 10a, 10b are shown greatly enlarged for clarity.

The optical circulator 90 in FIG. 5 routes an optical pulse signal received from an optical fiber 92 into the transmitting OCDM module 10a, receives an encoded chip pulse train from OCDM module 10a, and sends the encoded chip pulse train on an optical fiber 94 toward the receiving OCDM module 10b in FIG. 6. The optical circulator 90 in FIG. 6 receives the encoded chip pulse train from optical fiber 94, routes the encoded chip pulse train into the receiving OCDM module 10b, receives a decoded optical signal from OCDM module 10b, and outputs the decoded optical signal through another optical fiber 96.

The optical pulse input to OCDM module 10b in FIG. 5 encounters unit FBGs A1 to AM in sequence. At each unit FBG, a certain percentage of the optical energy is reflected back toward the optical circulator 90. These reflections generate M optical chip pulses from the input optical pulse. The reflected optical chip pulses return to the optical circulator 90 and are routed onto optical fiber 94 as an encoded signal. For convenience, the optical pulses are labeled with the same reference characters A1, A2, . . . , AM as the unit FBGs 74 by which they were reflected. Since the unit FBGs 74 are equally spaced, the M optical chip pulses are equally spaced on the time axis.

Mutually adjacent pairs of optical chip pulses on the time axis have a uniform phase difference Δφ. If the phase of optical chip pulse A1 is arbitrarily designated as zero, then the phase of optical chip pulse A2 is Δφ, the phase of optical chip pulse A3 is 2Δφ, and the phase of optical chip pulse AM is (M−1)Δφ.

Input of the encoded signal into the OCDM module 10b produces the result illustrated in FIG. 6. Each of the M optical chip pulses A1 to AM is reflected by each of the unit FBGs 74 in OCDM module 10b to generate a total of M×M optical chip pulses p-q, where p and q are integers from 1 to M: p identifies the unit FBG 74 by which the pulse was reflected in the encoder OCDM module 10a; q identifies the unit FBG 74 by which the pulse was reflected in the decoder OCDM module 10b.

An optical chip pulse reflected by the p-th encoder unit FBG Ap has a delay corresponding to (p−1)×2×La with respect to the optical chip pulse reflected by the first fiber Bragg grating A1. An optical chip pulse reflected by the q-th decoder unit FBG Bq has a delay corresponding to (q−1)×2×Lb with respect to the optical chip pulse reflected by the first fiber Bragg grating B1.

The optical chip pulse p-q reflected by unit FBG Ap in the encoder and unit FBG Bq in the decoder has a delay corresponding to

(p−1)×2×La+(q−1)×2×La=(p+q−2)×2×La

with respect to the optical chip pulse reflected by unit FBG A1 in the encoder and unit FBG B1 in the decoder. Therefore, optical chip pulses having identical values of p+q are aligned on the time axis when output from the decoder.

An optical chip pulse reflected by unit FBG Ap in the encoder has a phase delay corresponding to (p−1)×Δφa with respect to the optical chip pulse reflected by unit FBG A1. An optical chip pulse reflected by unit FBG Bq in the decoder has a phase delay corresponding to (q−1)×Δφa with respect to the optical chip pulse reflected by unit FBG B1.

The optical chip pulse p-q reflected by unit FBG Ap in the encoder and unit FBG Bq in the decoder has a phase delay corresponding to

(p−1)×Δφa+(q−1)×Δφa=(p+q−2)*Δφa

with respect to the optical chip pulse reflected by unit FBG A1 in the encoder and unit FBG B1 in the decoder. Therefore, optical chip pulses having identical values of p+q are in phase when they are output on the time axis from the decoder.

Optical chip pulses that are aligned on the time axis and are mutually in phase reinforce each other, thereby increasing the signal intensity of the corresponding part of the output from the decoder. These reinforcements generate an autocorrelation peak denoted by reference character 1 in the decoded signal. Each optical pulse input to the transmitting OCDM module 10a is detectable as a separate autocorrelation peak in the decoded signal, enabling the transmitted signal to be recovered.

The operation when the encoder and decoder are adjusted to use different codes will next be described. In the following example a signal is coded with the a-th code and decoded with the b-th code, where a and b are integers from 1 to N, b differing from a. La denotes the spacing of the unit FBGs 74 in the encoder; Lb denotes the spacing of the unit FBGs 74 in the decoder.

An optical chip pulse reflected by the p-th unit FBG Ap in the encoder has a delay corresponding to (p−1)×2×La with respect to the optical chip pulse reflected by the first unit FBG A1. An optical chip pulse reflected by the q-th unit FBG Bq in the decoder has a delay corresponding to (q−1)×2×Lb with respect to the optical chip pulse reflected by the first unit FBG B1.

An optical chip pulse reflected by unit FBG Ap in the encoder and unit FBG Bq in the decoder has a delay corresponding to (p−1)×2×La+(q−1)×2×Lb with respect to the optical chip pulse reflected by unit FBG A1 in the encoder and unit FBG B1 in the decoder. If Lb=La+ΔL, then:

(p−1)×2×La+(q−1)×2×Lb=(p+q−2)×2×La+(q−1)×2×ΔL

This equation indicates that when optical chip pulses with identical values of p+q but different values of q are output from the decoder, they are mutually shifted on the time axis by quantities equal to (q−1)×2×ΔL.

The optical chip pulse reflected by unit FBG Ap in the encoder has a phase delay corresponding to (p−1)×Δφa with respect to the optical chip pulse reflected by unit FBG A1. The optical chip pulse reflected by unit FBG Bq in the decoder has a phase delay corresponding to (q−1)×Δφb with respect to the optical chip pulse reflected by unit FBG B1.

The optical chip pulse reflected by unit FBG Ap in the encoder and unit FBG Bq in the decoder has a phase delay corresponding to (p−1)×Δφa+(q−1)×Δφb with respect to the optical chip pulse reflected by unit FBG A1 in the encoder and unit FBG B1 in the decoder. If b=a+Δa, the phase is shifted by (q−1)×2Δa×π/N, as obtained from the equation (1) below.

$$\begin{matrix}( p - 1 ) \times Δ φ a + ( q - 1 ) \times Δφ b = ( p - 1 ) \times ( 2 a - 1 ) \times π / N + \\ ( q - 1 ) \times ( 2 b - 1 ) \times π / N \\ = ( p - 1 ) \times ( 2 a - 1 ) \times π / N + \\ ( q - 1 ) \times ( 2 a + 2 Δ a - 1 ) \times π / N \\ = ( p + q - 2 ) \times ( 2 a - 1 ) \times π / N + \\ ( q - 1 ) \times 2 Δ a \times π / N \\ = ( p + q - 2 ) \times Δφ a + ( q - 1 ) \times \\ 2 Δ a \times π / N\end{matrix} \qquad ( 1 )$$

The optical chip pulses reflected by the p-th unit FBG Ap in the encoder and the q-th unit FBG Bq in the decoder are not aligned on the time axis even if they have identical values of p+q. Since the pulses are also out of phase, they do not reinforce each other and the signal intensity is comparatively low. As a result, the decoded signal does not have an autocorrelation peak, making it impossible to recover the transmitted optical signal.

In the OCDM module, heating and cooling by the thermo-module 36 is controlled so that the temperature set by the temperature controller 50 matches the temperature measured by the temperature sensor 42. This feedback control scheme keeps the thermo-module 36 and hence the mounting plate 40 at a uniform temperature, equal to the set temperature, despite ambient temperature variations.

Because of its high thermal conductivity, the mounting plate 40 does not have longitudinal temperature variations, so the entire SSFBG 72 in the optical fiber 70 lodged in the mounting plate 40 is kept at a constant temperature.

Since the mounting plate 40 has a low thermal expansion coefficient, its expansion and contraction due to temperature variations can be ignored; only the effect of temperature variations on the SSFBG 72 need be considered.

A temperature change in the SSFBG 72 changes the effective refractive index n_{eff} and grating pitch Λ of the unit FBGs 74 constituting the SSFBG 72. This changes the reflected wavelength of the unit FBGs 74 and also changes the length L of the unit chips 73 and the refractive index n of the core of the optical fiber 70 in which SSFBG is formed.

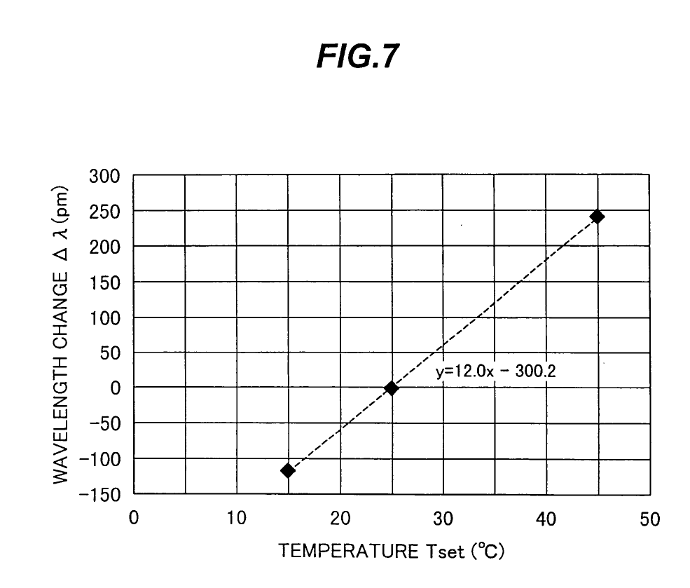

The relationship between SSFBG temperature and reflected wavelength will be described with reference to the graph showing in FIG. 7. The horizontal axis represents the temperature Tset (° C.) set by the temperature controller, and the vertical axis represents the change Δλ in picometers (pm) in reflection center wavelength with reference to the reflected wavelength when the set temperature Tset is 25° C. For brevity, the reflection center wavelength will be referred to simply as the reflected wavelength. Approximation of the set temperature Tset and the reflected wavelength change Δλ by a linear function gives the following equation (2).

Δλ=12.0×Tset−300.2 (2)

A change of 1° C. in the temperature Tset set in the temperature controller 50 changes the reflected wavelength λ by 12.0 pm. This means that temperature control in increments of 0.1° C. by the encoder and decoder provides reflected wavelength control with a resolution of about 1 pm.

When the thermo-module 36 heats the mounting plate 40, for example, thermal stress is eased by the buffers 34 and 38 as described below.

The thermo-module 36 generally has a different thermal expansion coefficient from the mounting plate 40 and housing 32, and the amount of expansion and contraction of the thermo-module 36 caused by a temperature change differs from the amount of expansion and contraction occurring in the mounting plate 40 and housing 32. If the thermo-module 36 were to be immovably secured to the mounting plate 40 or housing 32, the difference in expansion or contraction would produce stress on the Peltier element in the thermo-module 36 or on the solder joints at the electrodes of the Peltier element, eventually destroying the thermo-module 36.

In the structure described with reference to FIG. 2, the thermo-module 36 is secured to the housing 32 and mounting plate 40 through buffers 34 and 38 with buffer layers 80 that absorb differences in expansion or contraction between the thermo-module 36 and the housing 32 or mounting plate 40. This prevents thermal stress resulting from temperature variations from damaging the thermo-module.

If the buffers 34 and 38 are thin elements formed of materials having a high thermal conductivity, the thermal resistance of the buffers can be ignored.

In the present invention, in which the code is defined by the phase difference between adjacent optical chip pulses on the time axis, changing the SSFBG temperature changes the phase difference between adjacent chip pulses, consequently changing the code in the encoder or decoder.

The phase delay of a unit chip 73 depends on the length L and refractive index n of the unit chip 73 and the central reflected wavelength of the unit FBG 74, all of which are determined by the temperature of the mounting plate 40. The phase delay of each unit chip 73 determines the phase difference between adjacent optical chip pulses.

Let the a-th one of the N codes to be generated be denoted by {N-a}. For example, the code denoted {16-1} is the first of sixteen codes. The changing of code {16-1} to code {16-2} will be described below.

For code {16-1}, the phase difference between adjacent chip pulses is 0.19635 radians (=(2×a−1)×π/N=π/16=(1/32)×2π).

For code {16-2}, the phase difference between adjacent chip pulses is 0.58905 radians (=(3/32)×2π). Changing code {16-1} to code {16-2} requires a phase shift of 0.39270 radians (=0.58905 radians−0.19635 radians) in the encoder.

The phase difference Δφ defining code {N-a} can be expressed as follows in terms of the length L of the unit chip, the refractive index n of the optical fiber core, and the reflected wavelength λ₀.

Δφa=2×L×n/λ₀=(2×a−1)×π/N

To change from code {N-a} to code {N-b}, the temperature of the mounting plate is changed by an amount δT, changing the chip length L of the unit chip 73 by an amount δL. The temperature variation δT also changes the refractive index n by an amount δn. The phase difference Δφb (=(2×b−1)×π/N) is accordingly expressible as follows:

Δφb=2×(L+δL)×(n+δn)/λ₀

where the amount δ(Δφ) of change in phase difference is given by the equation (3) below.

$$\begin{matrix}δ ( Δφ ) = Δφ b - Δφa \\ = 2 \times ( L + δ L ) \times ( n + δ n ) / λ 0 - 2 \times L \times n / λ 0 \\ = 2 \times ( L \times δ n + δ L \times n + δ L \times δ n ) / λ0\end{matrix} \qquad ( 3 )$$

Results of experimental measurements of the change in code when a single-mode optical fiber with a germanium-doped core is used will now be described. In these measurements, the SSFBG 72 in the optical fiber 70 had unit FBGs 74 with a length L1 of 0.3 mm and phase adjustment regions 76 with a length L2 of 1.0 mm, that is, the unit chips 73 had a chip length L of 1.3 mm. The code length was thirty-two (M=32).

In these experiments, the thermal expansion coefficient of the optical fiber was 5.5×10⁻⁷/° C.; the refractive index n of the core was 1.45; the rate of change of the refractive index due to temperature was 8.6×10⁻⁶/° C.; the rate of change of the reflected wavelength due to temperature was 10 pm/° C.; the reflected wavelength of the unit FBGs 74 was 1549.32 nm.

The value of δL was accordingly 5.5×10⁻⁷×L×δT, and the value of δn was 8.6×10⁻⁶×δT. Substituting these expressions for δL and δn into the equation (3) above makes the amount of change δ(Δφ) in phase difference proportional to the temperature variation δT, since the contribution of the term δL×δn is small enough to be ignored. A temperature change of 1° C. changes the phase by 0.0986 radians. Therefore, the encoder could be changed from code {16-1} to code {16-2} by a temperature change of about 4° C.

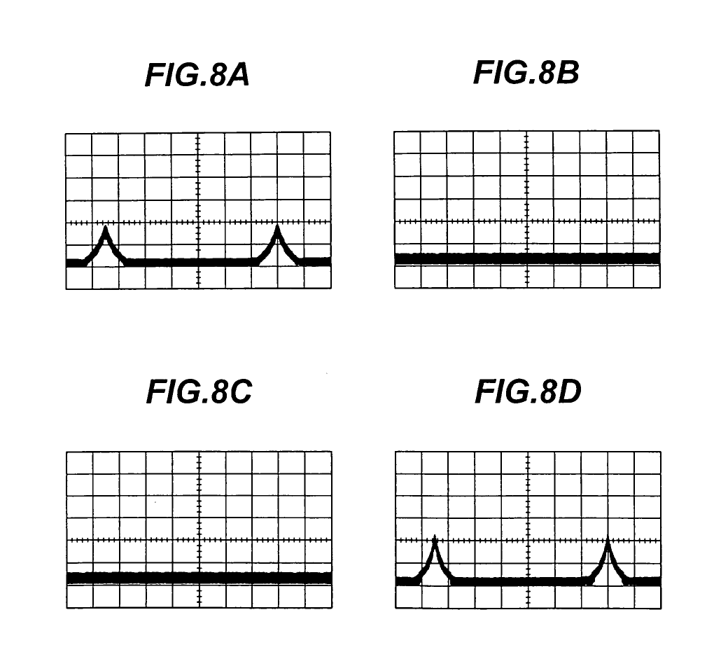

Results of measurement of signals encoded using codes {16-1} and {16-5} and decoded using codes {16-1} and {16-5} will be described with reference to FIG. 8A to FIG. 8D, which show waveforms of the decoded signals. In these graphs, the horizontal axis represents time and the vertical axis represents the reflected power, both in arbitrary units.

FIG. 8A shows a signal decoded by the decoder with code {16-5} after being encoded by the encoder with the same code {16-5}. An autocorrelation peak is observed, so the transmitted optical pulse signal is decoded and reproduced.

FIG. 8B shows signal decoded with code {16-1} after being encoded with code {16-5}. Because of the different codes used for encoding and decoding, no autocorrelation peak is observed. Accordingly, the transmitted optical pulse signal is not reproduced.

With code {16-1}, the phase difference between adjacent chip pulses is 0.19635 radians. With code {16-5}, the phase difference between adjacent chip pulses is 0.17615 radians (=9/3.2×2π). To change from code {16-5} to code {16-1}, a phase change corresponding to 1.57080 radians (=1.76715 radians−0.19635 radians) is necessary in the encoder.

With the encoder of this embodiment, the phase change resulting from a temperature change ΔT of 1° C. is 0.0986 radians, so the temperature change in the encoder should be about 16° C. (=1.57080 radians/0.0986 radians/° C.). The reflected wavelength of the SSFBG changes by 10 pm for each change of 1° C. in temperature, so a temperature change of 16° C. in the encoder changes the reflected wavelength of the SSFBG by 160 pm.

To change code {16-5} to code {16-1}, the temperature of the encoder needs to be lowered by about 16° C. This shortens the reflected wavelength by 160 pm.

FIG. 8C shows a signal decoded by the decoder using code {16-5} after being encoded by the encoder using code {16-1}. Because of the different encoding and decoding codes, no autocorrelation peak is observed. Accordingly, the transmitted optical pulse signal is not reproduced.

FIG. 8D shows a signal decoded by the decoder using code {16-1} after being encoded by the encoder using the same code {16-1}. Since the encoding and decoding codes are identical, an autocorrelation peak is observed, and the transmitted optical pulse signal is decoded and reproduced.

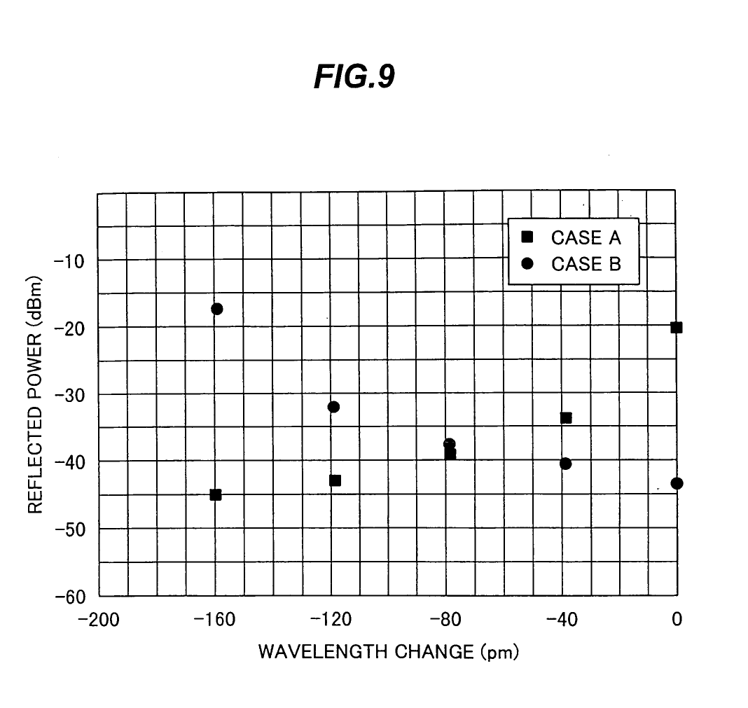

In FIG. 9, the horizontal axis indicates the reflected wavelength change in the encoder in picometers (pm), and the vertical axis represents the reflected power in milliwatt decibels (dBm). The data points represented by black squares indicate the reflected power when the decoder is set to use code {16-5}; the data points represented by black circles indicate the reflected power when the decoder is set to use code {16-1}.

If the code used by the encoder is initially {16-5}, the reflected power with the decoder set to use the same code {16-5} (case A) reaches a maximum value of about −20 dBm when the wavelength change in the encoder is 0 pm. The transmitted optical pulse signal can be reproduced by the decoder.

As the wavelength of the encoder is shortened by −40 pm, −80 pm, −120 pm, and −160 pm, the reflected power becomes smaller than −30 dBm, which is at least 10 dBm less than the reflected power obtained when the codes are the same. At this power level, the decoder cannot reproduce the transmitted optical pulse signal. Changing the reflected wavelength by −40 pm, −80 pm, −120 pm, and −160 pm in the encoder corresponds to changing the code used by the encoder to {16-4}, {16-3}, {16-2}, and {16-1}, respectively.

If the code used by the encoder is initially {16-5}, the reflected power obtained with the decoder set to use code {16-1} (case B) is smaller than −30 dBm when the wavelength change in the encoder is 0 pm, −40 pm, −80 pm, or −120 pm. The reflected power is at least 10 dBm smaller than the reflected power obtained when the codes are the same. In this case, the transmitted optical pulse signal cannot be reproduced by the decoder. Changing the reflected wavelength by 0 pm, −40 pm, −80 pm, −120 pm, and −160 pm in the encoder corresponds to changing the code used by the encoder to {16-5}, {16-4}, {16-3}, {16-2}, and {16-1} respectively.

If the wavelength of the encoder is shortened further to −160 pm, the reflected power is maximized at a value greater than −20 dBm. In that case, the decoder can reproduce the transmitted optical pulse signal. Altering the wavelength by −160 pm in the encoder corresponds to changing the code in the encoder from the initial code {16-5} to code {16-1}.

The optical code division multiplexing module and optical code division multiplexing method of the present invention use an SSFBG having a plurality of identical unit FBGs mutually separated by a plurality of phase adjustment regions of uniform length as an encoder and decoder. The temperature of the entire SSFBG defines the code. This eliminates the need for local heating to define the code, enabling encoding and decoding to proceed with long-term stability.

The code can be changed easily by changing the temperature of the entire SSFBG.

It will be appreciated that the temperature controller is not limited to the configuration shown in FIG. 1, the module package is not limited to the configuration shown in FIGS. 2 to 4, and invention can be practiced with materials other than those described above.

Those skilled in the art will recognize that other variations are also possible within the scope of the invention, which is defined in the appended claims.

What is claimed is:

1. An optical code division multiplexing module comprising:
a superstructured fiber Bragg grating having a plurality of mutually identical unit fiber Bragg gratings equally spaced in a single optical fiber;
a mounting plate to which the superstructured fiber Bragg grating is secured;
a thermo-module for heating or cooling the mounting plate;
a temperature sensor for measuring a temperature of the mounting plate; and
a temperature controller for controlling the thermo-module according to the temperature measured by the temperature sensor so as to adjust the temperature of the mounting plate, thereby setting a code for encoding and decoding by phase modulation.

2. The optical code division multiplexing module of claim 1, wherein:
the superstructured fiber Bragg grating has M unit fiber Bragg gratings, M being an integer greater than one, M also defining a code length of the code;
light incident to the superstructured fiber Bragg grating is reflected by the unit fiber Bragg gratings to generate M optical pulses; and
all pairs of the M optical pulses reflected by mutually adjacent pairs of the unit fiber Bragg gratings have a uniform phase difference Δφ which defines the code.

3. The optical code division multiplexing module of claim 2, wherein the phase difference Δφ varies with the temperature of the mounting plate.

4. The optical code division multiplexing module of claim 2, wherein the phase difference Δφ has a value given by the equation
Δφ=(2a−1)*π/N,
N being an integer greater than one denoting a number of codes and a being an integer from one to N indicating an a-th one of the N codes.

5. The optical code division multiplexing module of claim 1, wherein the thermo-module includes a Peltier element.

6. The optical code division multiplexing module of claim 1, wherein the mounting plate is made of a composite material including silicon carbide and silicon.

7. The optical code division multiplexing module of claim 1, wherein the superstructured fiber Bragg grating is lodged in a groove in the mounting plate.

8. The optical code division multiplexing module of claim 1, wherein the temperature sensor is mounted on a surface of the mounting plate.

9. The optical code division multiplexing module of claim 1, wherein the temperature sensor is embedded in the mounting plate.

10. The optical code division multiplexing module of claim 1, further comprising a buffer through which the thermo-module is secured to the mounting plate, for absorbing differences in thermal expansion and contraction between the thermo-module and the mounting plate.

11. The optical code division multiplexing module of claim 10, wherein the buffer includes a buffer layer having a planar elasticity modulus of at least ten percent.

12. The optical code division multiplexing module of claim 11, wherein the buffer layer has a heat transfer coefficient of at least 1 W/m·K.

13. The optical code division multiplexing module of claim 1, further comprising:
a housing enclosing the superstructured fiber Bragg grating, the temperature sensor, and the mounting plate; and
a buffer (34) through which the thermo-module is secured to the housing, for absorbing differences in thermal expansion and contraction between the thermo-module and the housing.

14. The optical code division multiplexing module of claim 13, wherein the buffer includes a buffer layer having a planar elasticity modulus of at least ten percent.

15. The optical code division multiplexing module of claim 14, wherein the buffer layer has a heat transfer coefficient of at least 1 W/m·K.

16. A method of encoding an optical signal by using an optical code division multiplexing module including a superstructured fiber Bragg grating having M mutually identical unit fiber Bragg gratings equally spaced in a single optical fiber, a mounting plate to which the superstructured fiber Bragg grating is secured, and a thermo-module for heating or cooling the mounting plate, M being an integer greater than one, the method comprising:
inputting an optical signal into the superstructured fiber Bragg grating;
reflecting the optical signal at the M unit fiber Bragg gratings to generate an encoded signal including M optical pulses in which all pairs of the M optical pulses reflected by mutually adjacent pairs of the unit fiber Bragg gratings have a uniform phase difference Δφ defining a code.

17. The method of claim 16, further comprising varying the phase difference by changing the temperature of the mounting plate.

18. The method of claim 16, wherein the phase difference Δφ has a value given by the equation
Δφ=(2a−1)*π/N,
N being an integer greater than one denoting a number of codes and a being an integer from one to N indicating an a-th one of the N codes.

19. The method of claim 18, wherein the unit fiber Bragg gratings are mutually separated by phase adjustment regions (76), the unit fiber Bragg gratings and phase adjustment regions constitute a unit chip with a unit chip length L, the optical fiber has a core refractive index n, and the unit fiber Bragg gratings reflect light of a wavelength λ₀, further comprising:
changing the temperature of the mounting plate by an amount ΔT, thereby changing the unit chip length L by an amount δL, changing the core refractive index n by an amount δn, changing the phase difference Δφ by an amount given by the equation
δ(Δφ)=2×{(L×δn)+(δL×n)+(δL×δn)}/λ₀
and so changing from the a-th code to a b-th code, b being another integer from one to N, b differing from a.
